(19) United States
(12) Patent Application Publication
(10) Pub. No.: US 2016/0180420 A1
(43) Pub. Date: Jun. 23, 2016

(54) VEHICLE TRANSACTION SYSTEMS AND METHODS

(71) Applicant: VISION DEALER SERVICES, LLC, North Fork, CA (US)

(72) Inventors: Danny Lynn Gamel, JR., Fresno, CA (US); Robert Earl Hallett, JR., Madera, CA (US)

(21) Appl. No.: 14/573,264

(22) Filed: Dec. 17, 2014

(51) Int. Cl. G06Q 30/06

(52) U.S. Cl. CPC G06Q 30/0609

(57) ABSTRACT

A system and method for distributing congested information comprising a mobile computing device including memory, a display screen, at least one processor in communication with the memory and display screen, and one or more components executable by the at least one processor and configured to display a four-square vehicle calculator interface, wherein the four-square calculator interface comprises four areas responsive to user input, receive input descriptive of a first vehicle purchase term at a first of the four areas, receive input descriptive of a second vehicle purchase term at a second of the four areas, receive input descriptive of a third vehicle purchase term at the third of the four areas, compute a fourth vehicle purchase term based on at least the first, second, and third vehicle purchase terms, and display the fourth vehicle purchase term at the fourth area in response to computing the fourth vehicle purchase term.

### BACKGROUND

1. Technical Field

The technical field of this disclosure relates generally to vehicle transaction systems and methods, and more specifically, to computer implemented tools that relieve congestion of vehicle purchasing information within vehicle transaction systems.

2. Discussion

Vehicle dealerships are in the business of selling new and used automobiles. Typically, dealerships advertise vehicles that they have available, and provide location or other contact information for potential customers to view the available vehicles. After interest is demonstrated in a particular vehicle, a sales person, often through in-person negotiation, attempts to convince the prospective customer to buy the vehicle. As a preliminary matter, the sales person typically collects the prospective customer's personal information including name, telephone number, E-mail address, trade-in vehicle information, and vehicle requirements, such as car size, budget, and other personal preferences. Conventional negotiation includes demonstration of the vehicle's features and benefits. For instance, this often involves a test drive.

Once the prospective customer has test driven the desired vehicle, the sales person will begin a negotiation process to convince the person to buy the vehicle through demonstration of the value of the vehicle. Conventionally, this includes establishing appealing purchase terms for the vehicle. A sale of the vehicle is consummated when the gap between the purchase terms the sales person has presented and the purchase terms the customer is prepared to accept have been bridged.

### SUMMARY

It is realized that new systems, applications, and tools are needed to relieve congestion of purchasing information relevant to customers in conventional vehicle dealership transaction systems. By distributing this information to multiple computing devices, the systems and methods disclosed herein facilitate bridging the gap in and between vehicle purchase terms presented by a sales person and purchase terms acceptable to a customer. According to some embodiments, vehicle dealerships, sales persons, sales managers, or prospective customers can access an application store for downloading or purchasing the four-square vehicle calculator. Once installed (e.g., on a mobile computing device, laptop, desktop, etc.) the user can generate one or more desired vehicle purchase terms based on entered values. For example, in various embodiments, the user can generate a vehicle purchase price, a down payment amount, a monthly payment amount, or a trade-in value, based on any three of vehicle purchase price, down payment amount, monthly payment amount, and vehicle trade-in value.

At least one aspect described herein is directed to a system for distributing congested information including a mobile computing device including a memory, a display screen, at least one processor in data communication with the memory and the display screen, and one or more components executable by the at least one processor. The one or more components can be collectively configured to display a four-square vehicle calculator interface via the display screen, wherein the four-square calculator interface comprises four areas responsive to user input, receive input descriptive of a first vehicle purchase term at a first of the four areas, receive input descriptive of a second vehicle purchase term at a second of the four areas, receive input descriptive of a third vehicle purchase term at the third of the four areas, compute a fourth vehicle purchase term based on at least the first, second, and third vehicle purchase terms, and display the fourth vehicle purchase term via the display screen at the fourth area in response to computing the fourth vehicle purchase term.

According to one embodiment, the first vehicle purchase term includes a vehicle trade-in value. In one embodiment, the plurality of the system components are collectively further configured to compute the vehicle trade-in value based on trade-in vehicle type, age, make, model, mileage, and condition. In one embodiment, the second vehicle purchase term includes a vehicle purchase price. In one embodiment, the third vehicle purchase term includes a down payment amount. In one embodiment, the fourth vehicle purchase term includes a monthly payment amount.

According to another embodiment, the plurality of the system components are collectively further configured to display a visual indicator of an external vehicle information source, wherein the external vehicle information source includes digital content including vehicle sale analytics and wherein the digital content for the external information source is provided from an online source. In one embodiment, the plurality of the system components are collectively further configured to display via the display screen the digital content of the external vehicle information source in response to selection of the visual indicator.

In one embodiment, the plurality of the system components are collectively further configured to transmit the first vehicle purchase term, second vehicle purchase term, third vehicle purchase term, and fourth vehicle purchase term via a communication network to a vehicle dealer. In another embodiment, the plurality of the system components are collectively further configured to receive an input descriptive of an amended first vehicle purchase term, an input descriptive of an amended second vehicle purchase term, an input descriptive of an amended third vehicle purchase term, and an input descriptive of an amended fourth vehicle purchase term from a vehicle dealer via a communication network in response to transmitting the first vehicle purchase term, second vehicle purchase term, third vehicle purchase term, and fourth vehicle purchase term.

Another aspect described herein is directed to a method of distributing congested information using a mobile computing device having a display screen, a user interface, and at least one processor operatively connected to a memory, the at least one processor configured to instantiate and run a plurality of system components when executing. The includes displaying a four-square vehicle calculator interface via the display screen, wherein the four-square calculator interface comprises four areas responsive to user input, receiving input descriptive of a first vehicle purchase term at a first of the four areas, receiving input descriptive of a second vehicle purchase term at a second of the four areas, receiving input descriptive of a third vehicle purchase term at the third of the four areas, computing a fourth vehicle purchase term based on at least the first, second, and third vehicle purchase terms, and displaying the fourth vehicle purchase term via the display screen at the fourth area in response to computing the fourth vehicle purchase term.

According to one embodiment, the first vehicle purchase term includes a vehicle trade-in value. In one embodiment, the method can further include computing the vehicle trade-in value based on trade-in vehicle type, age, make, model, mileage, and condition. In another embodiment, the second vehicle purchase term includes a vehicle purchase price. In one embodiment, the third vehicle purchase term includes a down payment amount. In another embodiment, the fourth vehicle purchase term includes a monthly payment amount.

In accordance with another embodiment, the method can further include displaying a visual indicator of an external vehicle information source, wherein the external vehicle information source includes digital content including vehicle sale analytics and wherein the digital content for the external information source is provided from an online source. In one embodiment, the method further includes displaying via the display screen the digital content of the external vehicle information source in response to selection of the visual indicator.

In accordance with one embodiment, the method can further include transmitting the first vehicle purchase term, the second vehicle purchase term, the third vehicle purchase term, and the fourth vehicle purchase terms via a communication network to a vehicle dealer. In one embodiment, the method can further include receiving input descriptive of an amended first vehicle purchase term, input descriptive of an amended second vehicle purchase term, input descriptive of an amended third vehicle purchase term, and input descriptive of an amended fourth vehicle purchase term from a vehicle dealer via a communication network in response to transmitting the first vehicle purchase term, second vehicle purchase term, third vehicle purchase term, and fourth vehicle purchase term.

Another aspect described herein is directed to a computer-implemented method of generating a vehicle sale between a prospective customer and a sales manager using a mobile computing device is provided. The mobile computing device includes a display screen, a user interface, and at least one processor operatively connected to a memory. The at least one processor is configured to instantiate and run a plurality of system components when executing the method. The method includes acts of generating a vehicle sales proposal, generating a vehicle sales counter-proposal, computing whether the vehicle purchase terms of the proposal substantially equal the vehicle purchase terms of the counter-proposal, and responsive to substantially equal vehicle purchase terms of the proposal and the counter-proposal, generating a sale of the vehicle. The act of generating a vehicle sales proposal can include displaying a four-square vehicle calculator interface via the display screen, wherein the four-square calculator interface comprises four areas responsive to user input, receiving input descriptive of a first vehicle purchase term at a first of the four areas from the prospective customer, receiving input descriptive of a second vehicle purchase term at a second of the four areas from the prospective customer, receiving input descriptive of a third vehicle purchase term at the third of the four areas from the prospective customer, computing a fourth vehicle purchase term based on at least the first, second, and third vehicle purchase terms, and displaying the fourth vehicle purchase term via the display screen at the fourth area in response to computing the fourth vehicle purchase term. The act of generating a vehicle sales counter-proposal can include receiving input descriptive of one of an amended first vehicle purchase term, an amended second vehicle purchase term, and an amended third vehicle purchase term from the sales manager, computing an amended fourth vehicle purchase term based on at least one of the amended first vehicle purchase term, the amended second vehicle purchase term, and the amended third vehicle purchase term, and displaying the amended fourth vehicle purchase term via the display screen at the fourth area in response to computing the amended fourth vehicle purchase term.

Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of a vehicle sales management system;

FIG. 2 is a schematic diagram of a computer system;

FIG. 3 is an illustration of a four-square vehicle calculator interface;

FIG. 4 is an illustration of a vehicle purchase term input window;

FIG. 5 is an illustration of a four-square vehicle calculator interface;

FIG. 6 is an additional illustration of a four-square vehicle calculator interface;

FIG. 7 is an illustration of a menu interface;

FIG. 8 is an illustration of a my rates window;

FIG. 9 is an illustration of a term indicator window;

FIG. 10 is an illustration of a my defaults window;

FIG. 11 is an illustration of a customer information interface; and

FIG. 12 is a process flow diagram of a method of distributing congested information.

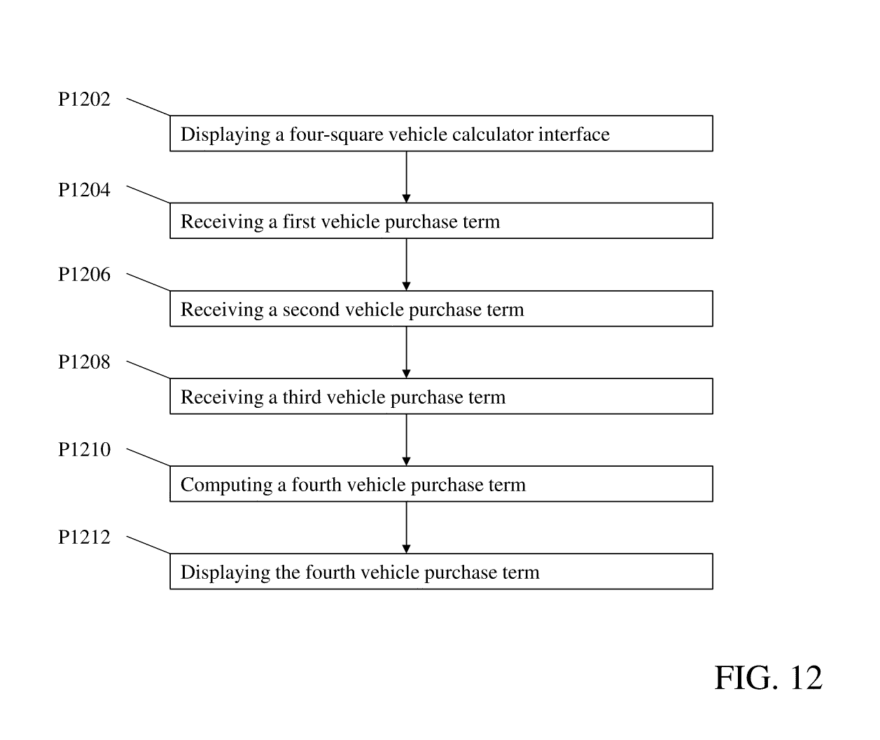

### DETAILED DESCRIPTION

Conventionally, vehicle sales persons have limited access to financial information. In a vehicle dealership, one, or a limited few, will have the ability to negotiate vehicle prices with regards to trade-in values, down payment amounts, or monthly payment amounts. Often this person is a sales manager. This is of particular concern when a prospective customer needs to budget or plan for future expenses and would like immediate access to information such as approximations of monthly car payments based on a trade-in amount or a down payment. For example, after taking a new vehicle for a test drive, the prospective customer may desire to know what a monthly payment would be if the purchase price is lowered by $500. Unfortunately, the sales person does not have immediate access to this information and must seek guidance from a sales manager. Assuming the sales person has not returned with purchase terms deemed acceptable by the prospective customer, this process must be repeated multiple times until agreeable terms have been reached. Consequently, conventional dealership transaction systems suffer from congestion of consumer relevant purchasing information at the sales manager's computing device. While the sales manager has access to all of the information that the prospective customer may desire, she is limited in distribution of the information. Although recent attempts to cure the deficiencies in conventional transaction systems have provided improvements in the vehicle search and information storage processes, these attempts still suffer from limited consumer access to relevant information, such as monthly payment amounts. For example, recent technological improvements in vehicle transaction systems include Internet-based vehicle purchase and sale platforms (e-commerce). Further improvements include Internet-based methods of communicating purchase requests to a vehicle dealer. Nevertheless, these systems still require a sales manager to provide requested information (e.g., monthly payment amounts) and, accordingly, suffer from a congestion of information at the sales manager's computing device.

The resulting bottleneck of information in conventional systems at the sales manager's computing device is economically wasteful, inconvenient, and often discourages vehicle sales. This issue becomes exacerbated during vehicle shows or exhibitions. Unlike a dealership, where there may be one sales manager available for two or three prospective customers, sales managers are less accessible at vehicle shows as a result of the greater population of prospective customers and spatial restraints. For example a typical RV show having ten RV dealers may attract anywhere from 20,000-30,000 prospective customers. Each dealership will have approximately two sales managers available resulting in roughly one sales manager for every 10,000-15,000 prospective customers.

Accordingly, some embodiments disclosed herein include app systems, applications, and tools configured to relieve the congestion of prospective customer relevant purchasing information and efficiently distribute information to bridge the gap in and between the vehicle price a sales person presents and the price a customer would like to pay for the vehicle. Embodiments as discussed herein include a four-square vehicle calculator that streamlines the vehicle sales negotiation process by releasing information typically congested at a sales manager's computing device. Accordingly, the four-square vehicle calculator decreases opportunity costs of conventional negotiation by decreasing the number of interactions required between a vehicle purchaser and a vehicle dealer to reach mutually acceptable terms. In this regard, various embodiments transform the time-consuming vehicle negotiation process between parties into an interactive process solely between a prospective customer and a sales person.

According to some embodiments, vehicle dealers, sales persons, sales managers, or prospective customers can access an application store for downloading or purchasing the four-square vehicle calculator. Once installed (e.g., on a mobile computing device, laptop, desktop, etc.) the user can compute a desired vehicle purchase term based on entered values. In various embodiments, the user can instantaneously compute, in real time, a vehicle purchase price, a down payment amount, a monthly payment amount, or a trade-in value, based on any three of vehicle purchase price, down payment amount, monthly payment amount, or vehicle trade-in value, removing the need to seek guidance from the sales manager.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Vehicle Transaction System

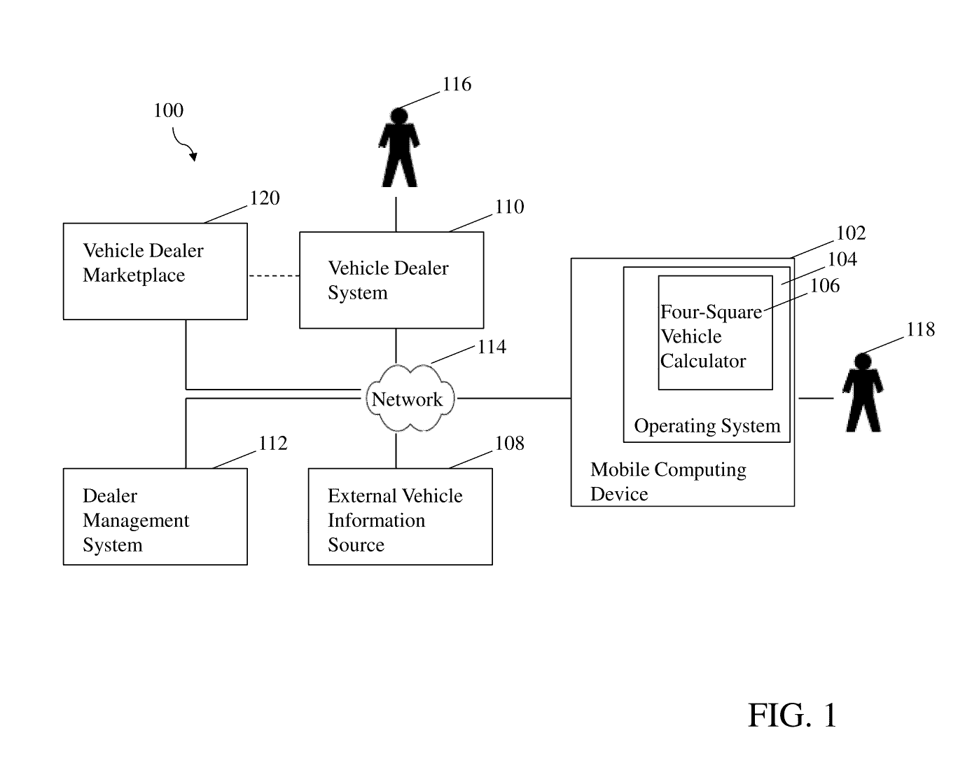

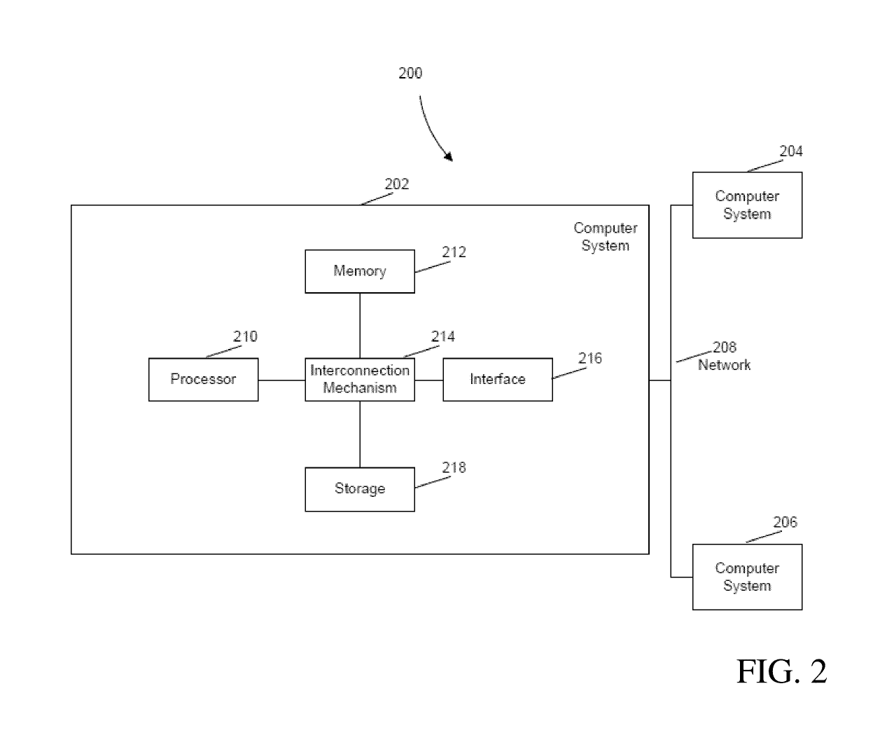

Some embodiments disclosed herein implement a system for relieving information congestion at a sales manager's computing device and managing vehicle sales using one or more computing systems, such as the computer system described below with reference to FIG. 2. According to these embodiments, the system executes a variety of processes that support computing vehicle purchase terms, such as vehicle prices, down payment amounts, monthly payment amounts, or trade in values. FIG. 1 illustrates an example system 100 for managing vehicle sales 100. As shown, the system 100 includes a mobile computing device 102, a vehicle dealer system 110, an external vehicle information source 108, a dealer management system 112, and a communications network 114. A user interacts (e.g., provides input and receives output) with the mobile computing device 102. The mobile computing device 102 includes an operating system 104 and a four-square vehicle calculator 106. The mobile computing device 102 may also include a memory, a display screen, and a processor.

In some embodiments, the four-square vehicle calculator 106 is a software component that calculates a fourth vehicle purchase term desired by the user 118 of the mobile computing device 102, based on first, second, and third previously entered vehicle purchase terms. In various embodiments, the user 118 of the device 102 is a prospective customer. In other embodiments, the user 118 is a car salesman at a vehicle dealership. Although various types of vehicle purchase terms may be calculated, the four-square vehicle calculator of one embodiment can compute a vehicle trade-in value, a vehicle purchase price, a down payment amount, or a monthly payment amount.

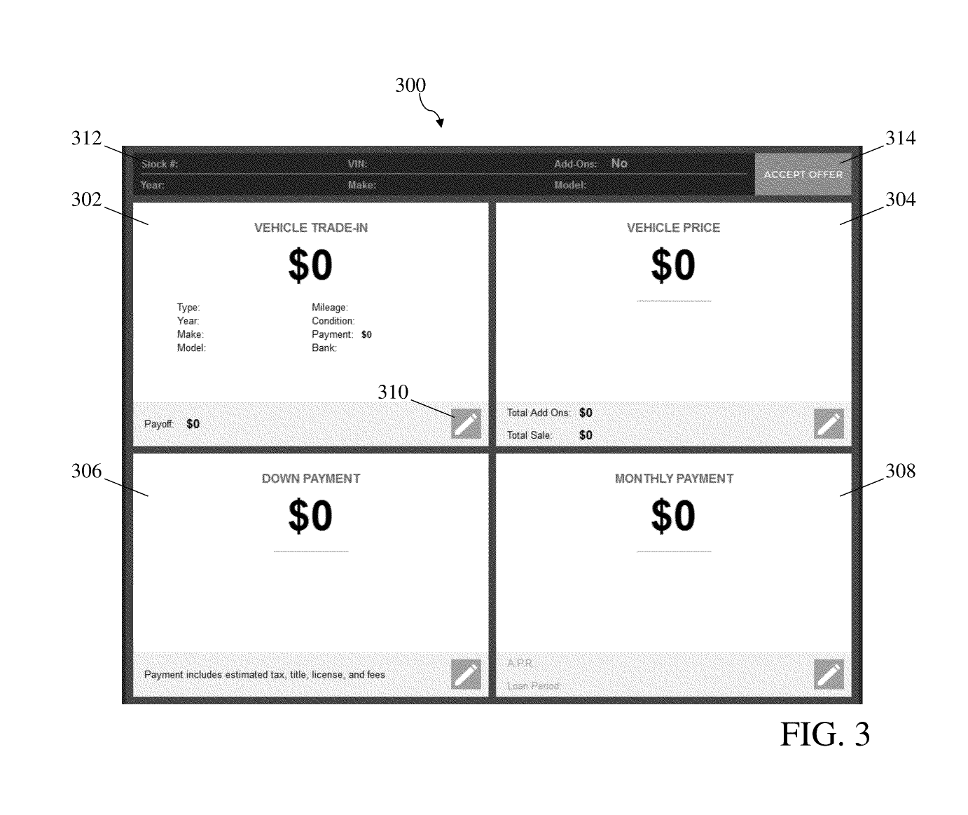

Referring now to FIG. 3, with continuing reference to FIG. 1, in various embodiments, the four-square vehicle calculator 106 includes a four-square vehicle calculator interface 300 capable of being displayed via the display screen of the mobile computing device 102. The interface 300 includes four square-shaped areas responsive to user input descriptive of a vehicle purchase term. In various embodiments, this includes a first area 302 configured to receive a first input descriptive of the first term, a second area 304 configured to receive a second input descriptive of the second term, a third area 306 configured to receive a third input descriptive of the third term, and a fourth area 308 configured to receive a fourth input descriptive of the fourth term. In various embodiments, responsive to receiving input descriptive of a vehicle purchase term, the four-square vehicle calculator 106 is configured to display the vehicle purchase term in a respective area of the interface 300, via the display screen.

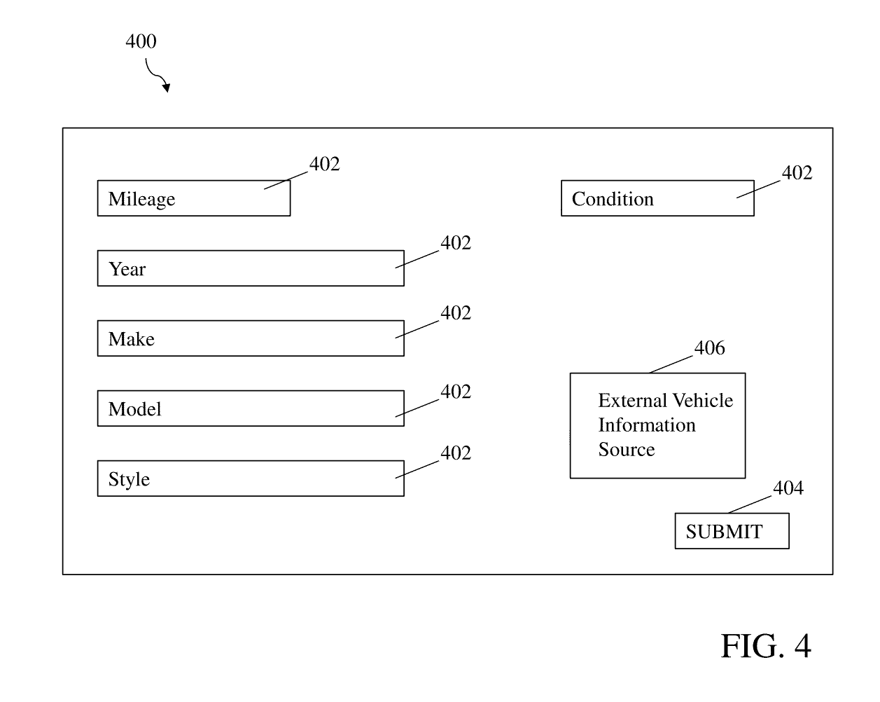

Turning briefly to FIG. 4, in other embodiments, the four-square vehicle calculator 106 is configured to display a vehicle purchase term input window 400 (shown in FIG. 4) in response to selection of an input indicator 310. The input window 400 is configured to receive the input descriptive of the vehicle purchase term entered by the user 118. FIG. 4 shows an input window 400 for a trade-in value vehicle purchase term. In various embodiments, the input window can include drop down menus, scroll menus, input boxes, or other user interface elements configured to receive input descriptive of the vehicle purchase term (indicated generally as 402). In response to entry of the input and selection of a submit indicator 404, the four-square vehicle calculator 106 is configured to display the vehicle purchase term in a respective area of the interface 300, via the display screen. FIG. 4 is not intended to be limiting and various other embodiments of the four-square vehicle calculator 106 can be configured to display an input window 400 for any other vehicle purchase term.

In one embodiment, the first vehicle purchase term includes a vehicle trade-in value. As used herein, vehicle trade-in value refers to the amount a vehicle dealer is willing to credit a prospective customer towards the purchase of a new vehicle for trading-in their current vehicle. In an embodiment, this value may be entered as a flat amount, such as $2500. In other embodiments, the four-square vehicle calculator 106 is configured to receive information descriptive of the trade-in vehicle at the first area 302, such as, type, age, make, model, mileage, condition, remaining payments, and bank. In response to entry of information descriptive of the trade-in vehicle, the four-square vehicle calculator 106 can compute the trade-in value by referencing vehicle valuation data. As used herein, vehicle valuation data includes vehicle appraisal values generated from at least previous sales of the same vehicle. Such data can be stored and retrieved from an external vehicle information source, such as external information source 108 described in detail below.

In other embodiments, the vehicle purchase term input window 400 further includes a visual indicator 406 of an external vehicle information source 108. Although the information source can include various types of information sources, the information source of one embodiment includes KELLEY BLUE BOOK®, National Automobile Dealers Association (NADA), MANHEIM®, and/or Car Think. In response to user entry of information descriptive of the trade-in vehicle, or selection of the visual indicator 406, the four-square vehicle calculator 106 can import and display, via the display screen, content including vehicle sale analytics from the external vehicle information source 108. In an embodiment, the vehicle sale analytics can include vehicle valuation data such as vehicle appraisal values. In other embodiments, vehicle sale analytics can include vehicle reviews, dealer reviews, price quotes, or other vehicle educational information. Instantaneous real time access to vehicle sales analytics increases the speed of the vehicle sales negotiation and allows a user of the mobile computing device 102 to ensure that a trade-in amount for their current vehicle, or the purchase price of the new vehicle, is an accurate and credible price.

In one embodiment, the second vehicle purchase term includes a vehicle purchase price. Vehicle purchase price, as used herein, describes the price of the vehicle the prospective customer wishes to purchase. In various embodiments, this can include the base price of the vehicle, the sale price of the vehicle, the price of the vehicle with taxes, title, license, or other fees included, or the price of the vehicle with add-ons. In one embodiment, the four-square vehicle calculator 106 is configured to first receive input descriptive of the purchase price of the vehicle at the second area 304. Then, in response to receiving the input descriptive of the purchase price, the four-square vehicle calculator is configured to query the user to enter additional expenses associated with the purchase of the vehicle. As described above, the four-square vehicle calculator 106 can be configured to display an input window 400 in response to selection of an input indicator 310. The input window 400 is configured to receive the input descriptive of a vehicle purchase term entered by the user 118, such as, in this case, the vehicle purchase price. In additional embodiments, vehicle purchase prices are imported and incorporated into the four-square vehicle calculator 106 from an information management system of vehicle dealer inventory data, such as a dealer management system 112 (discussed below).

In one embodiment, the third vehicle purchase term includes a down payment amount. Down payment amount, as used herein, refers to the amount the prospective customer proposes to pay on sale of the new vehicle. As described above, the four-square vehicle calculator 106 can be configured to display a vehicle purchase an input window 400 in response to selection of an input indicator 310. The input window 400 is configured to receive the input descriptive of a vehicle term entered by the user 118, such as, in this case, the down payment amount.

In one embodiment, the fourth vehicle purchase term includes a monthly payment amount. As used herein, monthly payment amount refers to the amount the prospective customer will pay the seller/financier/bank/creditor of the vehicle each month following sale of the vehicle to pay off the remainder of the purchase price. In addition to the monthly payment amount, the fourth area 308 can be further configured to receive input descriptive of an annual percentage rate (APR) and loan term. For example, the user 118 of the mobile computing device may specify in the fourth area 308 of the four-square vehicle calculator 106 that they desire a monthly payment of $400 at an APR of 2% for a term of 36 months. In another example, the user 118 of the mobile computing device may only specify at the fourth area 308 that they desire a monthly payment of $400, without any APR or loan term information. In yet a further embodiment, the four-square vehicle calculator can be configured to adjust an APR or loan term based on real time access to the user's credit rating or financial information. As described above, the four-square vehicle calculator 106 can be configured to display an input window 400 in response to selection of an input indicator 310. In one embodiment, the input window 400 is configured to receive the input descriptive of a vehicle purchase term entered by the user 118, such as, in this case, the monthly payment amount.

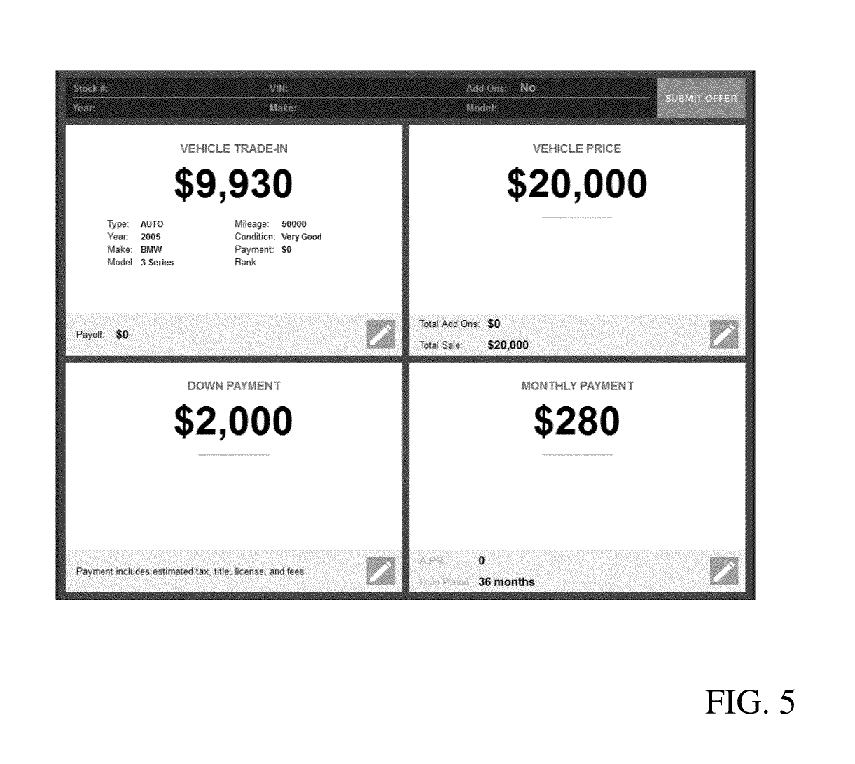

Referring now to FIG. 5, with continuing reference to FIGS. 1 and 3, in response to receiving input descriptive of vehicle purchase terms, in various embodiments, the four-square vehicle calculator 106 is configured to compute a desired vehicle purchase term based on at least the entered input. For example, in response to receiving the first input descriptive of the first vehicle purchase term at the first area 302, the second input descriptive of the second vehicle purchase term at the second area 304, and the third input descriptive of the third vehicle purchase term at the third area 306, the four-square vehicle calculator can compute and display the fourth vehicle term at the fourth area 308. In one embodiment, the fourth vehicle purchase term includes the monthly payment amount. In other embodiments, the fourth term can include the down payment amount, the purchase price amount, or the trade-in value.

In one embodiment, monthly payment amount is computed according to the following equation:

Monthly payment amount=[(P+F)−(T+D)]/[payment term]

Where, P is the vehicle purchase price, T is the trade-in amount, D is the down payment amount, and F is estimated tax, title, license, and fees. For example, FIG. 4, shows a vehicle trade-in value of $9,930 (first vehicle purchase term), a vehicle purchase price of $20,000 (second vehicle purchase term), and a down payment amount of $2,000 (third vehicle purchase term). Based on the foregoing, the computed monthly payment amount is $280 (fourth vehicle purchase term), over a term of 36 months. Although not shown in the equation above, in other embodiments, the monthly payment amount can include interest based on financing. In one embodiment, interest based on financing is automatically incorporated into the monthly payment amount. The four-square vehicle calculator 106 can be configured to default to the interest rate most favorable to the vehicle dealership. In other embodiments, the interest rate can default to the interest rate most favorable to the prospective customer.

Instantaneous real time availability of a monthly payment amount allows a prospective customer to budget accordingly when purchasing a new vehicle, and allows a car salesman to negotiate with a prospective customer without unnecessarily interrupting the negotiation to seek guidance from a sales manager. Accordingly, the vehicle four-square calculator system streamlines the vehicle sales negotiation process by redistributing information typically congested at a sales manager's computing device, decreasing the number of interactions between the parties. In this regard, various embodiments excise the repeated intervention of a sales manager.

In further embodiments, the four-square vehicle calculator 106 is configured to update the display of the first area 302, the second area 304, the third area 306, and the fourth area 308 in response to input descriptive of an amended vehicle purchase term at a respective area. Furthermore, the four-square vehicle calculator 106 is further configured to compute update vehicle purchase terms in response to entry of input descriptive of an amended input at one of the four areas. For example, in response to amending the down payment amount shown in FIG. 5 to $5,000, the four-square vehicle calculator 106 is configured to update the monthly payment amount at the fourth area 308 accordingly. As such, the amended vehicle purchase term at the fourth area 308 would be $196. The amount is displayed in the fourth area 308 of the four-square vehicle calculator interface 300, replacing the first computed amount of $280. In various embodiments, the four-square vehicle calculator interface 300 includes one or more selections permitting the user 118 to specify to which area updates are made. For example, the interface 300 can include a pay cash, a roll to trade, roll to down, or a roll to price selection. Each selection enables to user to specify the one or more areas to which updates will be made in response to entering an input descriptive of an amended vehicle purchase term. As such, the four-square vehicle calculator 106 provides a platform for tailoring a vehicle purchase proposal to a prospective customer or vehicle dealer's specific financial demands.

Turning back to FIG. 1, the mobile computing device 102 is capable of exchanging information, via the communication network 114, with a vehicle dealer system 110, an external vehicle information source 108, or a dealer management system 112. This information may support four-square vehicle calculator information as described below. The network 114 may include any communication network through which computer system exchange information. For example, the network 114 may be any public network, such as the Internet, and may include other public or private networks such as LANs, WANs, extranets, intranets, and cloud computing systems. The network may also include cellular networks, such as LTE, 4G, HSDPA/HSUPA, TD-SCDMA, W-CDMA, CDMA, WiFi, Bluetooth, EvDo, GSM, and iDEN networks.

In one embodiment, the mobile computing device 102 is capable of sending the first, second, third, and fourth vehicle purchase terms in the four-square vehicle calculator via the communication network 114 to a vehicle dealer 116. Accordingly, transmission and receipt of vehicle purchase terms facilitates remote vehicle sales negotiation. In this embodiment, the sent vehicle purchase terms are received at a vehicle dealer system, such as vehicle dealer system 110 shown in FIG. 1. Although various types of vehicle dealer systems may be used, the system of one embodiment can include a computer system, as described below with reference to FIG. 2. In additional embodiments, the mobile computing device 102 is further configured to send personal information, such as prospective customer name, phone number, e-mail address, or postal address to the vehicle dealer 116. Such personal information can be used to identify the prospective customer. In some embodiments personal information is stored in user profiles.

In various embodiments, the vehicle dealer system 110 includes an installed four-square vehicle calculator, such as the four-square vehicle calculator 106. The four-square vehicle calculator installed on the vehicle dealer system 110 is configured to display the four received vehicle purchase terms in a four-square vehicle purchase term interface, such as interface 300. In additional embodiments, the dealer system 110 can be configured to store, locally or remotely, the received vehicle purchase terms and personal information. In this regard, stored historical vehicle purchase terms can be used to identify purchaser demands, purchasing trends, individual purchaser preferences, or to customize future vehicle offerings to specific customers.

In additional embodiments, the four-square vehicle calculator on the vehicle dealer system 110 is configured to update the display of the first area, the second area, the third area, and the fourth area in response to input descriptive of an amended vehicle purchase term at the respective area from the user of the dealer system. Accordingly, the vehicle dealer 116, in response to receiving the four vehicle purchase terms from the user 118, may amend one of the terms. For example, if the vehicle dealer does not agree with the vehicle purchase price, she may amend that term to an amount she is more comfortable with.

In another embodiment, the mobile computing device 102 is configured to receive an amended first vehicle purchase term, an amended second vehicle purchase term, an amended third vehicle purchase term, or an amended fourth vehicle purchase term from the vehicle dealer 116 via the communication network 114. Once received by the mobile computing device 102, the four-square vehicle calculator 106 incorporates the received data into the four-square vehicle calculator interface 300. Accordingly, the four-square vehicle calculator 106 is a platform for instantaneous vehicle sales negotiation between a vehicle dealer 116 and user 118 of the mobile computing device 102. For example, the user 118 of the mobile computing device 102 can create a vehicle sales proposal including four vehicle purchase terms (e.g., trade-in value, vehicle purchase price, down payment amount, and monthly payment amount) with the four-square vehicle calculator 106. After creating the proposal, the mobile computing device 102 is configured to transmit the proposal to the vehicle dealer 116. In various embodiments, this can be done by selection of an “accept offer” icon 314 in the four-square vehicle calculator interface 300. Upon receiving the vehicle sales proposal at the vehicle dealer system 110, the dealer 116 is prompted with the four-square vehicle calculator interface showing the proposed vehicle purchase terms. In response to receiving the proposal, the vehicle dealer 116 can amend, one, two, three, or all of the proposed terms and transmit a counter-proposal to the user 118. Upon receiving the counter-proposal, the four-square vehicle calculator 106 incorporates the counter-proposal into the four-square vehicle calculator interface 300. This exchange may be repeated continually until vehicle purchase terms amenable to the user 118 and the vehicle dealer 116 have been achieved.

In another embodiment, the mobile computing device 102 is capable of sending the vehicle sales proposal via the communication network 114 to a vehicle dealer marketplace 116 accessible by a plurality of vehicle dealers through respective individual dealer systems (e.g., vehicle dealer system 110). Transmission of the four vehicle purchase terms to the vehicle dealer marketplace facilitates widespread availability of the proposal. Accordingly, the vehicle dealer marketplace 120 enables the prospective customer to market the proposal to all interested dealers. In various embodiments, the four-square vehicle calculator is further configured to specify intended recipients of the proposal. For example, the user of the four-square calculator can instruct the four-square vehicle calculator to target only used-car dealerships within a 50 mile radius of the prospective customer's location.

In another embodiment, the mobile computing device 102 is configured to communicate with a dealer management system 112. According to an embodiment, the dealer management system 112 includes an information management system for vehicle dealers. The dealer management system 112 can include a central server which stores data accessible by user devices, such as the mobile computing device 102. In an embodiment, the dealer management system 112 includes vehicle dealer inventory data. This can include stock number, vehicle identification number (VIN), add-ons, year, make, model, condition, price, or any other information descriptive of a vehicle. The management system 112 may further include status indicators for a sale related to the vehicle, such as “accepted”, “msg/customer”, “desk”, or “customer.” Status indicators describe the progress of a vehicle sale, and indicate if a vehicle is no longer available for sale. Accordingly, the dealer management system 112 provides for electronic inventory and customer management.

In an embodiment, the mobile computing device 102 is configured to transmit a request for vehicle inventory data from the dealer management system 112. The request can be specified for a particular vehicle, a vehicle make or model, or a vehicle type. In response to receiving the request, the dealer management system 112 retrieves the data and transmits the requested data to the mobile computing device 102. Once received by the mobile computing device 102, the four-square vehicle calculator 106 incorporates the received data into the four-square vehicle calculator interface 300. In various embodiments, this includes displaying the stock number, the VIN, the add-ons, the year, the make, and the model in a display header 312 (shown in FIG. 3).

As discussed above, in an embodiment, the system 100 includes one or more external vehicle information sources 108 in communication with the mobile computing device 102. External vehicle information sources 108 can include repositories of vehicle sales analytics such as KELLEY BLUE BOOK®, National Automobile Dealers Association (NADA), MANHEIM®, and/or Car Think. The mobile computing device 102 is configured to transmit a request for vehicle sales analytics in response to selection of a visual indicator in the four-square vehicle calculator interface 300. Once the sales analytics are received, the four-square vehicle calculator 106 is configured to display the received information in the four-square vehicle calculator interface 300, via the display screen. In various embodiments, vehicle sales analytics can include appraisal values, vehicle reviews, dealer reviews, price quotes, or other vehicle educational information.

In some embodiments, the mobile computing device 102 is configured to provide users with an interface that facilitates the instantaneous negotiation of vehicle sales. When executing according to this configuration, the mobile computing device 102 executes the operating system 104. The operating system 104 may be any commercially available operating system, such as iOS, Android, Areas, Mac OS, Linux, etc. The operating system executes the four-square vehicle calculator 106.

Information may flow between the components illustrated in FIG. 1, or any of the elements, components and subsystems disclosed herein, using a variety of techniques. Such techniques include, for example, passing the information over a network using standard protocols, such as TCP/IP, HTTP, or HTTPS, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Within the system 100, data may be stored in any logical construction capable of storing information on a computer readable medium including, among other structures, flat files, indexed files, search engine indexes, hierarchical databases, relational databases or object oriented databases. These data structures may be specifically configured to conserve storage space or increase data exchange performance. In addition, various examples organize the data into particularized and, in some cases, unique structures to perform the functions disclosed herein. In these examples, the data structures are sized and arranged to store values for particular types of data, such as integers, floating point numbers, character strings, arrays, linked lists, and the like. In addition, while FIG. 1 illustrates a multiple mobile computing devices (e.g., 102, 110, etc.), other embodiments include a single mobile computing device such as the mobile computing device 102. Thus, embodiments are not limited to any particular number of mobile computing devices.

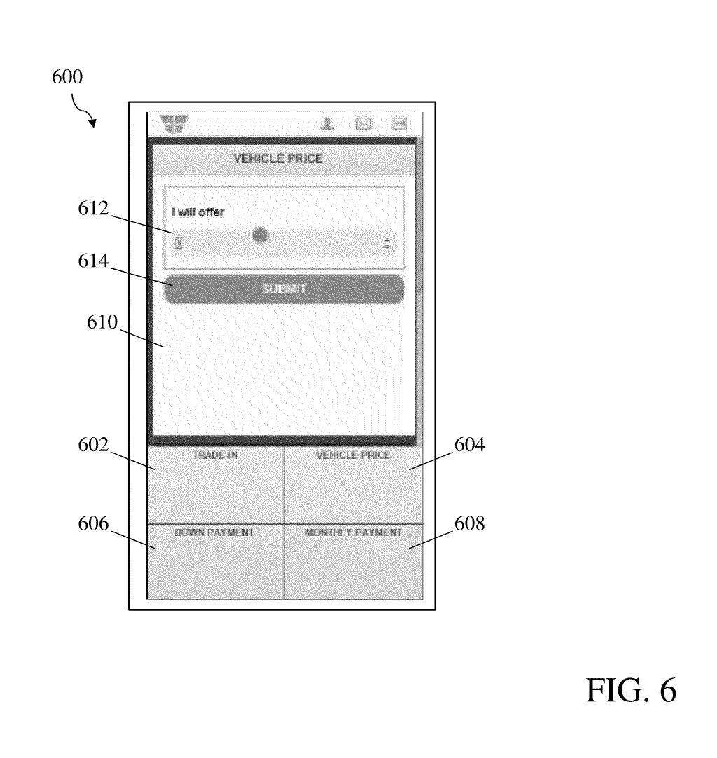

FIG. 6 shows an additional embodiment of a vehicle four-square calculator interface. In various embodiments, the four-square vehicle calculator 106 discussed herein can include a four-square vehicle calculator interface 600 capable of being displayed via the display screen of the mobile computing device 102. The interface 600 includes four square-shaped areas responsive to user input descriptive of a vehicle purchase term. In various embodiments, this includes a first area 602 configured to receive a first input descriptive of the first term, a second area 604 configured to receive a second input descriptive of the second term, a third area 606 configured to receive a third input descriptive of the third term, and a fourth area 608 configured to receive a fourth input descriptive of the fourth term. In various embodiments, responsive to receiving input descriptive of a vehicle purchase term, the four-square vehicle calculator 106 is configured to display the vehicle purchase term in a respective area of the interface 600, via the display screen. The four-square vehicle calculator interface 600 also includes a vehicle purchase term input window, shown generally as input window 610. The input window 610 is configured to receive the input descriptive of the vehicle purchase term entered by the user 118. FIG. 6 shows an input window 610 for a vehicle price. In various embodiments, the input window 610 can include drop down menus, scroll menus, input boxes, or other user interface elements (indicated generally as 612) configured to receive input descriptive of the vehicle purchase term. In response to entry of the input and selection of a submit indicator 614, the four-square vehicle calculator 106 is configured to display the vehicle purchase term in a respective area of the interface 600, via the display screen.

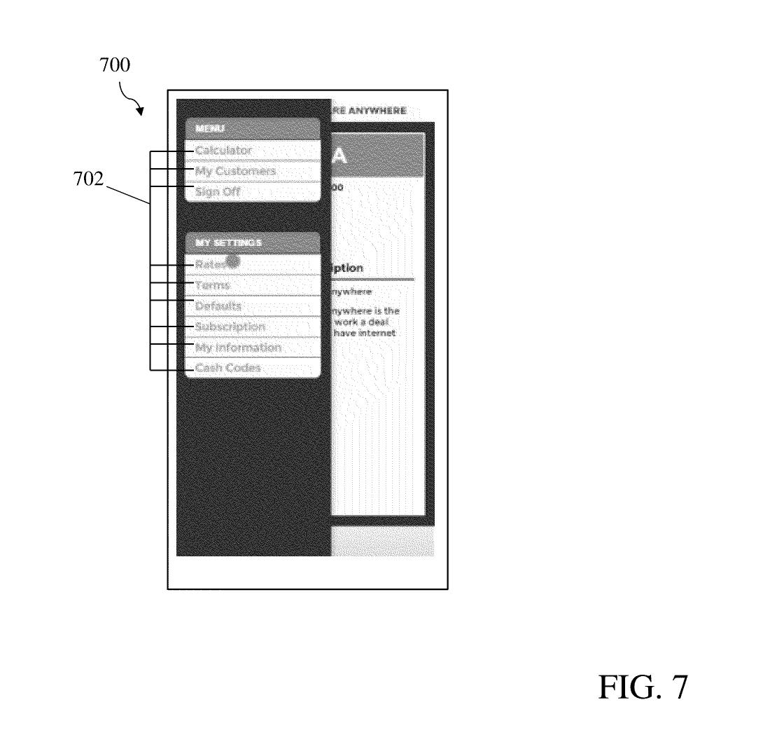

In various embodiments, the four square vehicle calculator 106 can further include a menu interface permitting the user 118 to move between vehicle purchase term input windows (e.g. input window 610) or other interfaces within the interface 600. FIG. 7 shows an example menu interface 700 configured to display one or more indicators 702 offering a plurality of selections laid out in rows or columns. As shown in FIG. 7, in one embodiment, the menu interface 700 can include a calculator indicator for displaying a four-square vehicle calculator interface (e.g., interface 600), a my customers indicator for displaying customer information, a sign off indicator for exiting the four-square vehicle calculator 106, a rates indicator for displaying loan term rates, a terms indicator for displaying loan terms, a defaults indicator for displaying default settings, a subscription indicator for displaying four-square vehicle calculator subscription settings, a my information indicator for displaying user information, and a cash codes indicator for displaying cash offer options. Selection of an indicator 702 displays the corresponding interface or window.

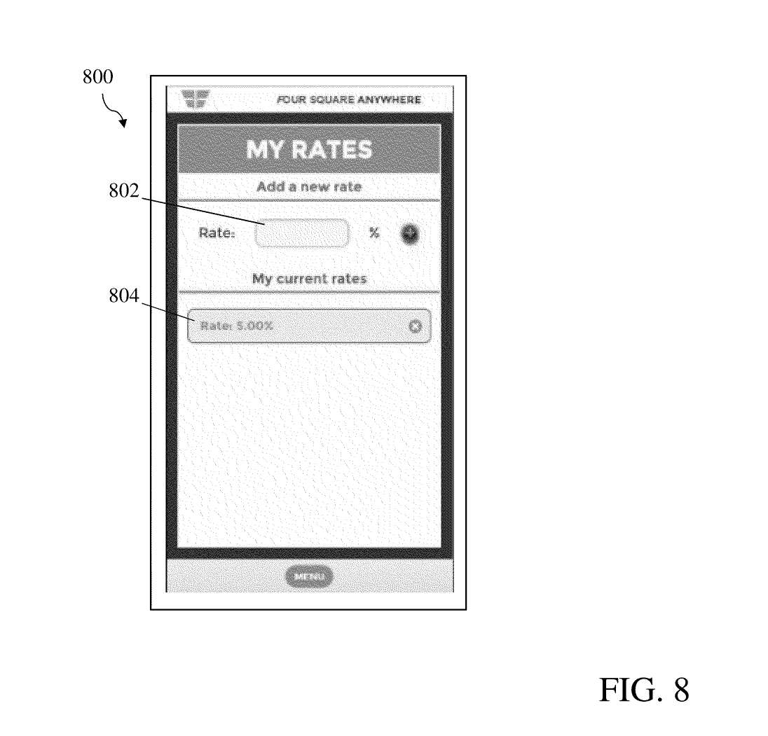

For example, FIG. 8 shows a my rates window 800. In various embodiments, the my rates window 800 includes one or more boxes 802 configured to receive input descriptive of an annual percentage rate (APR). For example, the user 118 of the mobile computing device may specify in box 802 that she desires an APR of 2%. In another example, window 800 further includes one or more selectable predetermined APRs 804. FIG. 8 shows a selectable APR of 5%. In yet a further embodiment, the four-square vehicle calculator can be configured to adjust the predetermined APR based on real time access to the user's credit rating or financial information. The four-square vehicle calculator 106 is configured to automatically incorporate user selection of a predetermined APR, or entry of an APR rate into the four-square vehicle calculator interface (e.g., interface 600).

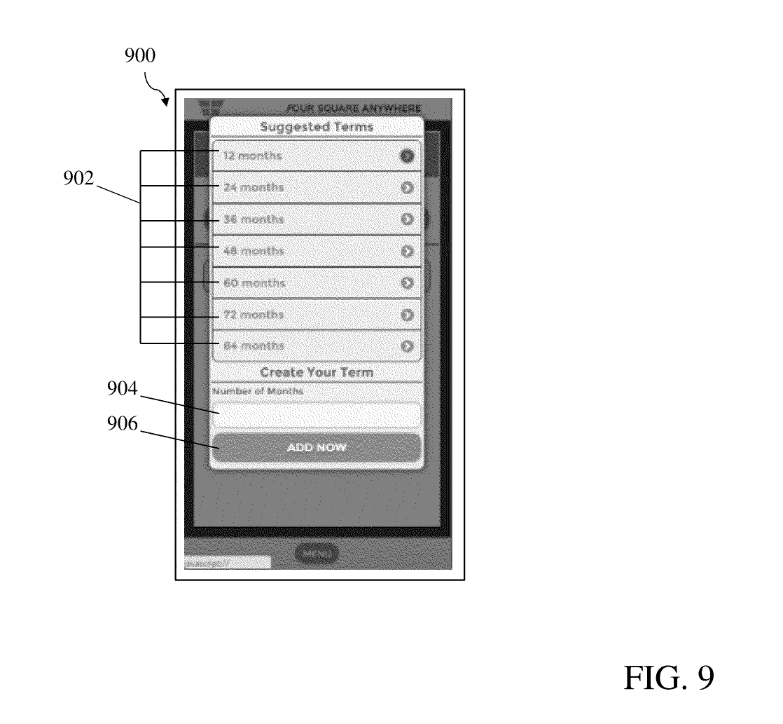

FIG. 9 shows a terms indicator window 900. In various embodiments, the terms indicator window 900 includes one or more loan term selections 902. As discussed herein, loan term includes the duration of the loan requested to purchase the desired vehicle. The terms indicator window 900 permits the user 118 of the device to specify a loan term. For example, FIG. 8 shows loan terms of 12, 24, 36, 48, 60, 72, and 84 months. In various embodiments, the window 900 may further include an input box 906 permitting the user 118 to manually enter a loan term not provided in a loan term selection 902. Selection of a submit indicator (shown as add now indicator 908) automatically incorporates the selected loan term in to the four-square vehicle calculator interface (e.g., interface 600).

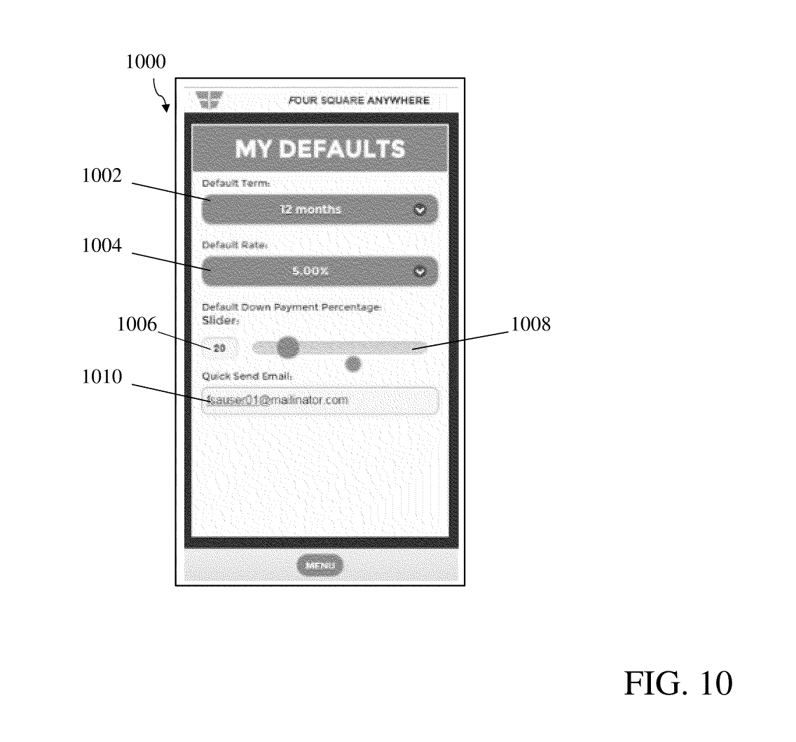

FIG. 10 shows a my defaults window 1000. In various embodiments, the user 118 may not want to specify the loan term or the APR every time the four-square vehicle calculator 106 is used. Accordingly, the my defaults window 1000 permits the user 118 to set a default configuration for loan term and APR. As shown, the window 1000 can include a default term indicator 1002 configured to receive a default loan term and a default rate indicator 1004 configured to receive a default APR. For example, FIG. 10 shows a default term of 12 months and a default rate of 5%. Accordingly, the defined default loan term and default APR are automatically incorporated into the four-square vehicle calculator interface (e.g., interface 600). In various embodiments, the my defaults window 1000 can further include a default down payment indicator 1006. In one embodiment the indicator 1006 includes a sliding scale indicator 1008 permitting the user 118 to define a default down payment amount. In other embodiments, the indicator 1006 includes an input box. Accordingly, the default down payment amount is automatically incorporated into the four square vehicle calculator interface (e.g., interface 600). Furthermore, in various embodiments the my defaults window 1000 may include a quick send email indicator 1010. Selection of the indicator 1010 permits the user to enter an email address to send or receive communicated four square vehicle purchase proposals, as discussed above.

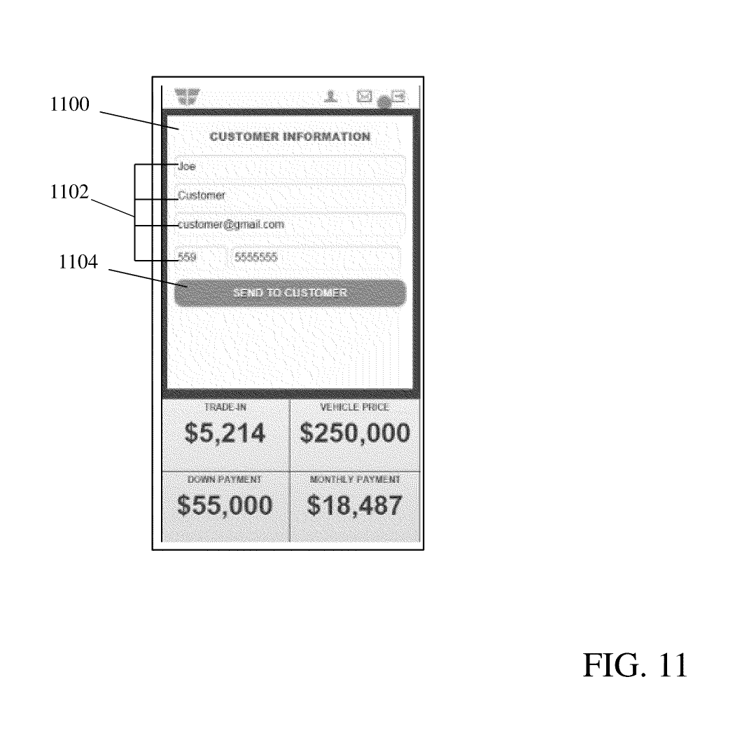

Turning now to FIG. 11, in various embodiments the four-square vehicle calculator 106 can further include a customer information interface 1100. As discussed above, the four-square vehicle calculator 106 can be configured to receive and send personal information, such as prospective customer name, phone number, e-mail address, or postal address to the vehicle dealer 116. Such personal information can be used to identify the prospective customer, associate the prospective customer with a vehicle sales proposal, or define a prospective customer to whom to send a vehicle sales proposal. In various embodiments, the customer information interface 1100 is configured to receive customer identifying information. FIG. 11 shows an example customer information interface 1100 as including input boxes 1102 for name, email, and phone number. In various embodiments, the interface may additionally include input boxes 1102 for address, date of birth, social security number, drivers license number, drivers license state, home and mobile phone number, or other prospective customer identifying information such as personal vehicle preferences. Interface 1100 can also include a send to customer (or seller) indicator 1104. Selection of the send to customer indicator permits the user of the device to submit the contents of the vehicle four-square calculator interface (e.g., interface 600) to the prospective customer defined by the entered customer information. Although shown in FIG. 11 as identifying one prospective customer, in various embodiments, the window 1102 can be configured to receive identifying information for two or more prospective customers. For example, interface 1100 may include one or more tabs permitting the user of the device to jump between identifying information for a first applicant (i.e., prospective customer) and a second applicant.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices (e.g., smart phones, tablet computers, laptop computers, and personal digital assistants) and network equipment (e.g., load balancers, routers, and switches). Examples of particular models of mobile computing devices include iPhones, iPads, and iPod touches running iOS operating system available from Apple, Android devices like Samsung Galaxy Series, LG Nexus, and Motorola Droid X, Blackberry devices available from Blackberry Limited, and Areas Phone devices. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions are practiced. As shown, the distributed computer system 200 includes one or more computer systems that exchange information. More specifically, the distributed computer system 200 includes computer systems 202, 204, and 206. As shown, the computer systems 202, 204, and 206 are interconnected by, and may exchange data through, a communication network 208. The network 208 may include any communication network through which computer systems may exchange data. To exchange data using the network 208, the computer systems 202, 204, and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 202, 204, and 206 may transmit data via the network 208 using a variety of security measures including, for example, SSL or VPN technologies. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, an interconnection element 214, an interface 216 and data storage element 218. To implement at least some of the aspects, functions, and processes disclosed herein, the processor 210 performs a series of instructions that result in manipulated data. The processor 210 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 210 is connected to other system components, including one or more memory devices 212, by the interconnection element 214.

The memory 212 stores programs (e.g., sequences of instructions coded to be executable by the processor 210) and data during operation of the computer system 202. Thus, the memory 212 may be a relatively high performance, volatile, random access memory such as a dynamic random access memory (“DRAM”) or static memory (“SRAM”). However, the memory 212 may include any device for storing data, such as a disk drive or other nonvolatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the interconnection element 214. The interconnection element 214 may include any communication coupling between system components such as one or more physical busses in conformance with specialized or standard computing bus technologies such as IDE, SCSI, PCI and InfiniB and. The interconnection element 214 enables communications, including instructions and data, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage element 218 includes a computer readable and writeable nonvolatile, or non-transitory, data storage medium in which instructions are stored that define a program or other object that is executed by the processor 210. The data storage element 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage element 218. The memory may be located in the data storage element 218 or in the memory 212, however, the processor 210 manipulates the data within the memory, and then copies the data to the storage medium associated with the data storage element 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (“ASIC”) tailored to perform a particular operation disclosed herein. While another example may perform the same operation using a grid of several general-purpose computing devices running MAC OS System X with Intel processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Areas-based operating system, such as, Areas NT, Areas 2000 (Areas ME), Areas XP, Areas Vista, Areas Phone, or Areas 7 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in an area of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Vehicle Transaction Process

As described above with reference to FIG. 1, some embodiments execute various vehicle sales management and negotiation processes and relieve congestion of consumer relevant purchasing information at a sales manager's computing device. In various embodiments, sales management and negotiation processes include a four-square vehicle calculator that circumvents the need for a sales manager during a vehicle sales negotiation. The four-square vehicle calculator decreases opportunity costs of conventional negotiation by decreasing the number of interactions required between a vehicle purchaser and a vehicle dealer to reach mutually acceptable terms. In this regard, various embodiments transform the time-consuming vehicle negotiation process between parties into an interactive process solely between a prospective customer and a sales person.

FIG. 6 illustrates an example vehicle sales management process executed by a sales management system, such as the vehicle sales management system 100 described above with reference to FIG. 1. In one embodiment, the process includes a method of managing vehicle sales using a mobile computing device having a display screen, a user interface, and at least one processor operatively connected to a memory, the at least one processor configured to instantiate and run a plurality of system components when executing, the method including:

P1202: Displaying a four-square vehicle calculator interface via the display screen, wherein the four-square calculator interface (e.g., four-square calculator interface 300 shown in FIG. 3) comprises four areas responsive to user input. In various embodiments, the interface includes four square-shaped areas responsive to user input descriptive of a vehicle purchase term. This includes a first area configured to receive a first input descriptive of the first term, a second area configured to receive a second input descriptive of the second term, a third area configured to receive a third input descriptive of the third term, and a fourth area configured to receive a fourth input descriptive of the fourth term.

P1204: Receiving input descriptive of a first vehicle purchase term at a first of the four areas. In one embodiment, the first vehicle purchase term includes a vehicle trade-in value. For example, this value can be entered as a flat amount, such as $2500. In other embodiments, receiving input descriptive of a first vehicle purchase term includes receiving information descriptive of the trade-in vehicle, such as, type, age, make, model, mileage, condition, remaining payments, and bank. In response to entry of information descriptive of the trade-in vehicle, the method can include computing the trade-in value by referencing vehicle valuation data. In various embodiments, vehicle valuation data is imported from an external vehicle information source having a repository of vehicle appraisal values.

In one embodiment, receiving input descriptive of a first vehicle purchase term includes displaying an input window in response to selection of an input indicator. The input window is configured to receive the input descriptive of the vehicle purchase term entered by the user. For example, the input window can include drop down menus, scroll menus, input boxes, or other user interface elements configured to receive input descriptive of the vehicle purchase term. Responsive to entry of the input descriptive of the first vehicle purchase term in the input window, the method can further include displaying, in the first area, the first vehicle purchase term.

In other embodiments, the input window further includes a visual indicator of an external vehicle information source, such as KELLEY BLUE BOOK®, National Automobile Dealers Association (NADA), MANHEIM®, and/or Car Think. In response to user entry of information descriptive of the trade-in vehicle, or selection of the visual indicator, the method can include displaying, in the input window, vehicle sales analytics from the external vehicle information source. As realized herein, instantaneous access to sales analytics, such as reviews and appraisal values, ensures that the vehicle-trade in value is accurate and credible.

P1206: Receiving input descriptive of a second vehicle purchase term at a second of the four areas. In one embodiment, the second vehicle purchase term includes a vehicle purchase price. In various embodiments, this can include the base price of the vehicle, the sale price of the vehicle, the price of the vehicle with taxes, title, license, or other fees included, or the price of the vehicle with add-ons. In another embodiment, responsive to receiving input descriptive of the purchase price of the vehicle at the second area, the method can further include receiving input descriptive of additional expenses associated with purchase price of the vehicle. As described herein, additional expenses can include taxes, title, license, or other fees. In further embodiments, in response to receiving input descriptive of a second vehicle purchase term at the second area, the method can further include, displaying, in the second area, the second vehicle purchase term.

P1208: Receiving input descriptive of a third vehicle purchase term at the third of the four areas. In one embodiment, the third vehicle purchase term includes a down payment amount. As described herein, the down payment amount refers to the amount the prospective customer proposes to pay on sale of the new vehicle. In various embodiments, the method further includes, displaying, in the third area, the third vehicle purchase term, in response to receiving input descriptive of the third vehicle purchase term.

In various embodiments, and as discussed above, receiving input descriptive of the first, second, or third vehicle purchase term at the first, second, or third, area includes displaying a vehicle purchase term input window, such as input window 400 described above with reference to FIG. 4, in response to selection of an input indicator. In accordance with this embodiment, the method can further include receiving input descriptive of a vehicle term through the input window, and displaying the vehicle purchase term entered in the input window in the four-square vehicle calculator interface.

P1210: Computing a fourth vehicle purchase term based on at least the first, second, and third vehicle purchase terms. In one embodiment, the fourth vehicle purchase term includes a monthly payment amount. In various other embodiments, the fourth vehicle purchase term may include a vehicle purchase price, a down payment amount, or a vehicle trade-in value.

P1212: Displaying the fourth vehicle purchase term via the display screen at the fourth area in response to computing the fourth vehicle purchase term. Instantaneous real time computation and display of a monthly payment amount allows a prospective customer to budget accordingly when purchasing a new vehicle, and allows a car salesman to negotiate with a prospective customer without unnecessarily interrupting the negotiation to seek guidance from a sales manager. Accordingly, processes as described herein streamline the vehicle sales and negotiation process decreasing the amount of wasted time and interactions between a prospective customer and a vehicle dealer.

As described herein, additional embodiments can further include displaying a visual indicator of an external vehicle information source, wherein the external vehicle information source includes digital content, and displaying the digital content via the display screen in response to selection of the visual indicator. The visual indicator can be displayed in the input window or the four-square vehicle calculator interface. External vehicle information sources can include repositories of vehicle sales analytics such as KELLEY BLUE BOOK®, National Automobile Dealers Association (NADA), MANHEIM®, and/or Car Think. As discussed above, the digital content may be displayed in the input window of the four-square vehicle calculator interface. In other embodiments, the digital content may be displayed in the first, second, third, or fourth area, or in a separate interface. The mobile computing device is configured to transmit a request for vehicle sales analytics in response to selection of the visual indicator, receive the vehicle sales analytics, and display the vehicle sales analytics.

In one embodiment, the method further includes transmitting the first vehicle purchase term, the second vehicle purchase term, the third vehicle purchase term, and the fourth vehicle purchase term to a vehicle dealer. In another embodiment, the method further includes sending personal data of the user of the mobile computing device, such as prospective customer name, phone number, e-mail address, or postal address to the vehicle dealer. The sent vehicle purchase terms are received at a vehicle dealer system, such as the vehicle dealer system shown in FIG. 1. In various embodiments, the vehicle dealer system includes an installed four-square vehicle calculator, such as the four-square vehicle calculator described herein. The four-square vehicle calculator installed on the vehicle dealer system is configured to display, via a display screen, the four received vehicle purchase terms in a four-square vehicle purchase term interface. In further embodiments, the method includes updating the display of the first area, the second area, the third area, and the fourth area in response to receiving input descriptive of an amended vehicle purchase term at the respective area. Accordingly, a vehicle dealer, in response to receiving the four vehicle purchase terms from the user, may amend one of the terms, for example the purchase price.

In another embodiment, the method further includes receiving an amended first vehicle purchase term, an amended second vehicle purchase term, an amended third vehicle purchase term, and an amended fourth vehicle purchase term from a vehicle dealer via a communication network in response to transmitting the first vehicle purchase term, second vehicle purchase term, third vehicle purchase term, and fourth vehicle purchase term. For example, a user of the mobile computing device can create a vehicle sales proposal including four vehicle purchase terms, trade-in value, vehicle purchase price, down payment amount, monthly payment amount. After creating the proposal, the method can include sending the proposal to the vehicle dealer. Upon receiving the proposal at the vehicle dealer system, the dealer is prompted with the four-square vehicle calculator interface showing the proposed vehicle purchase terms. In response to receiving the proposal, the vehicle dealer can amend one, two, or any of the proposed terms, and send a counter-proposal to the user including the amended term(s). This exchange may be repeated continually until vehicle purchase terms amenable to both to vehicle dealer and the prospective customer have been achieved.

In yet another embodiment, the method can further include storing, locally or remotely, the received vehicle purchase terms and personal information at the dealer device. In this regard, stored historical vehicle purchase terms can be used to identify purchaser demands, purchasing trends, individual purchaser preferences, or to customize future vehicle offerings to specific prospective customers.

In another embodiment, methods as described herein further include sending the vehicle sales proposal via a communication network to a vehicle dealer marketplace (e.g., dealer marketplace 120 shown in FIG. 1) accessible by a plurality of vehicle dealers through respective individual dealer systems. Transmission of the four vehicle purchase terms to the vehicle dealer marketplace facilitates widespread availability of the proposal. Accordingly, the vehicle dealer marketplace enables the prospective customer to market the proposal to all interested dealers. In various embodiments, the method can further include specifying intended recipients of the proposal. For example, the user of the four-square calculator can instruct the four-square vehicle calculator to target only used-car dealerships within a 50 mile radius of the prospective customer's location. In yet another embodiment, the method can include transmitting a request for vehicle inventory data from a dealer management system, such as the dealer management system 112 described above with reference to FIG. 1. In an embodiment, the dealer management system includes vehicle dealer inventory data. This can include stock number, vehicle identification number (VIN), add-ons, year, make, model, condition, price, or any other information descriptive of a vehicle. The management system may further include status indicators for a sale related to the vehicle, such as “accepted”, “msg/customer”, “desk”, or “customer.” The request can be specified for a particular vehicle, a vehicle make or model, or a vehicle type.

In response to receiving the request at the dealer management system, the method may further include retrieving vehicle inventory data and transmitting the retrieved data to the mobile computing device. Once received by the mobile computing device, received data can be incorporated into the four-square vehicle calculator interface. In various embodiments, this includes displaying the stock number, the VIN, the add-ons, the year, the make, and the model in a display header.

Having thus described several aspects of at least one embodiment, it is to be appreciated that various alterations, modifications, and improvements will readily occur to those skilled in the art. Examples and embodiments disclosed herein may also be used in other contexts. For instance, while some embodiments disclosed herein focus on apps deployed to mobile computing devices, other embodiments may develop apps for and deploy apps to immobile computing devices, such as computing devices affixed to a kiosk, wall, industrial panel, or some other immobile structure. Still other embodiments develop apps for and deploy apps to any computer system. Such alterations, modifications, and improvements are intended to be part of this disclosure, and are intended to be within the scope of the examples discussed herein. Accordingly, the foregoing description and drawings are by way of example only.

What is claimed is:

1. A system for distributing congested information comprising a mobile computing device including:
a memory;
a display screen;
at least one processor in data communication with the memory and the display screen; and
one or more components executable by the at least one processor and collectively configured to:
display a four-square vehicle calculator interface via the display screen, wherein the four-square calculator interface comprises four areas responsive to user input,
receive input descriptive of a first vehicle purchase term at a first of the four areas,
receive input descriptive of a second vehicle purchase term at a second of the four areas,
receive input descriptive of a third vehicle purchase term at the third of the four areas,
compute a fourth vehicle purchase term based on at least the first, second, and third vehicle purchase terms, and
display the fourth vehicle purchase term via the display screen at the fourth area in response to computing the fourth vehicle purchase term.

2. The system of claim 1, wherein the first vehicle purchase term includes a vehicle trade-in value.

3. The system of claim 2, wherein the plurality of the system components are collectively further configured to compute the vehicle trade-in value based on trade-in vehicle type, age, make, model, mileage, and condition.

4. The system of claim 2, wherein the second vehicle purchase term includes a vehicle purchase price.

5. The system of claim 4, wherein the third vehicle purchase term includes a down payment amount.

6. The system of claim 5, wherein the fourth vehicle purchase term includes a monthly payment amount.

7. The system of claim 1, wherein the plurality of the system components are collectively further configured to display a visual indicator of an external vehicle information source, wherein the external vehicle information source includes digital content including vehicle sale analytics and wherein the digital content for the external information source is provided from an online source.

8. The system of claim 8, wherein the plurality of the system components are collectively further configured to display via the display screen the digital content of the external vehicle information source in response to selection of the visual indicator.

9. The system of claim 1, wherein the plurality of the system components are collectively further configured to transmit the first vehicle purchase term, second vehicle purchase term, third vehicle purchase term, and fourth vehicle purchase term via a communication network to a vehicle dealer.

10. The system of claim 9, wherein the plurality of the system components are collectively further configured to receive an input descriptive of an amended first vehicle purchase term, an input descriptive of an amended second vehicle purchase term, an input descriptive of an amended third vehicle purchase term, and an input descriptive of an amended fourth vehicle purchase term from a vehicle dealer via a communication network in response to transmitting the first vehicle purchase term, second vehicle purchase term, third vehicle purchase term, and fourth vehicle purchase term.

11. A method of distributing congested information using a mobile computing device having a display screen, a user interface, and at least one processor operatively connected to a memory, the at least one processor configured to instantiate and run a plurality of system components when executing, the method comprising:
displaying a four-square vehicle calculator interface via the display screen, wherein the four-square calculator interface comprises four areas responsive to user input;
receiving input descriptive of a first vehicle purchase term at a first of the four areas;
receiving input descriptive of a second vehicle purchase term at a second of the four areas;
receiving input descriptive of a third vehicle purchase term at the third of the four areas;
computing a fourth vehicle purchase term based on at least the first, second, and third vehicle purchase terms; and
displaying the fourth vehicle purchase term via the display screen at the fourth area in response to computing the fourth vehicle purchase term.

12. The method of claim 11, wherein the first vehicle purchase term includes a vehicle trade-in value.

13. The method of claim 12, further comprising computing the vehicle trade-in value based on trade-in vehicle type, age, make, model, mileage, and condition.

14. The method of claim 12, wherein the second vehicle purchase term includes a vehicle purchase price.

15. The method of claim 14, wherein the third vehicle purchase term includes a down payment amount.

16. The method of claim 15, wherein the fourth vehicle purchase term includes a monthly payment amount.

17. The method of claim 11, further comprising displaying a visual indicator of an external vehicle information source, wherein the external vehicle information source includes digital content including vehicle sale analytics and wherein the digital content for the external information source is provided from an online source.

18. The method of claim 17, further comprising displaying via the display screen the digital content of the external vehicle information source in response to selection of the visual indicator.

19. The method of claim 11, further comprising transmitting the first vehicle purchase term, the second vehicle purchase term, the third vehicle purchase term, and the fourth vehicle purchase terms via a communication network to a vehicle dealer.

20. The method of claim 19, further comprising receiving input descriptive of an amended first vehicle purchase term, input descriptive of an amended second vehicle purchase term, input descriptive of an amended third vehicle purchase term, and input descriptive of an amended fourth vehicle purchase term from a vehicle dealer via a communication network in response to transmitting the first vehicle purchase term, second vehicle purchase term, third vehicle purchase term, and fourth vehicle purchase term.
